(19) United States
(12) Patent Application Publication
(10) Pub. No.: US 2026/0339852 A1
(43) Pub. Date: Oct. 29, 2026

(54) ADAPTER CONTROL CIRCUIT WITH STORAGE FUNCTIONALITY AND MULTIFUNCTIONAL ADAPTER

(71) Applicant: Haichuang Shicheng Technology (Shenzhen) Co., Ltd., Shenzhen (CN)

(72) Inventor: Meiru Liu, Shenzhen (CN)

(21) Appl. No.: 19/192,453

(22) Filed: Apr. 29, 2025

(51) Int. Cl. G06F 13/10

(52) U.S. Cl. CPC G06F 13/102

(57) ABSTRACT

The present disclosure relates to an adapter control circuit with storage functionality and a multifunctional adapter. The adapter control circuit with storage functionality comprises a first interface circuit configured to connect to a mobile device, a power input circuit electrically connected to the first interface circuit, a storage module, and a plurality of second interface circuits. The power input circuit and the plurality of second interface circuits are configured to connect to an external power source and external functional devices, respectively. Through the first interface circuit, the adapter control circuit is configured to connect to the mobile device, allowing the mobile device to be charged via the power input circuit connected to an external power source, to expand its storage capacity via the storage module, and to connect to a plurality of functional devices via the second interface circuits. This configuration enables expanded connectivity and usability for the mobile device.

### FIELD OF THE INVENTION

The present disclosure relates to the field of mobile device accessories, and more particularly to an adapter control circuit with storage functionality and a multifunctional adapter.

### BACKGROUND OF THE INVENTION

Currently, in order to achieve thinner and lighter designs, mobile phones and tablet computers have increasingly integrated their interface functionalities, allowing a single port to support multiple purposes. As a result, the number of ports available on mobile devices has significantly decreased. Most mainstream flagship mobile devices now feature only a single universal interface, through which the device handles charging, audio playback, and connections to external devices.

However, because current mobile devices typically provide only one universal interface, the device can generally perform only one wired function at a time. For example, when a USB flash drive or other external storage device is connected, the device cannot be charged simultaneously, nor can it connect to functional accessories such as headphones or microphones.

### SUMMARY OF THE INVENTION

The embodiments of the present disclosure provide an adapter control circuit with storage functionality and a multifunctional adapter, aiming to address the technical problem of inconvenient usage resulting from the reduced number of terminal interfaces in current mobile devices.

To achieve the above purpose, according to a first aspect, the present disclosure provides an adapter control circuit with storage functionality. The adapter control circuit comprises a first interface circuit configured to connect to a mobile device, a power input circuit electrically connected to the first interface circuit, a storage module, and a plurality of second interface circuits. The power input circuit is configured to connect to an external power source, and the second interface circuits are configured to connect to external functional devices.

Preferably, the first interface circuit comprises a mobile device connection plug, which is a Type-C plug, a Micro USB plug, or a Lightning plug.

Preferably, the mobile device connection plug is a third Type-C plug J3. The Dp and Dn ports of the third Type-C plug J3 are electrically connected to the second interface circuits. The VBUS port of the third Type-C plug J3 is connected to the power input circuit. The CC1 port of the third Type-C plug J3 is connected to both the power input circuit and the storage module. The CC2 port of the third Type-C plug J3 is connected to the storage module. Two sets of TXp ports, TXn ports, RXp ports, and RXn ports of the third Type-C plug J3 are respectively electrically connected to eight corresponding ports of the storage module. The GND port of the third Type-C plug J3 is connected to ground.

Preferably, the power input circuit comprises a power connection plug, a power control circuit, and a power conversion circuit. The power connection plug is configured to connect to an external power source. The power control circuit and the power conversion circuit are connected to the power connection plug. The power control circuit is electrically connected to the first interface circuit and the second interface circuits. A power output terminal of the power conversion circuit is electrically connected to the storage module and the second interface circuits.

Preferably, the power connection plug is a first Type-C plug J1. The power conversion circuit comprises a DC-DC power chip U1 and an inductor L1. An input terminal of the DC-DC power chip U1 is connected to a VBUS port of the first Type-C plug J1. An output terminal of the DC-DC power chip U1 is connected to a first end of the inductor L1. A second end of the inductor L1 is connected to a voltage bus VBUS. A VBUS output port is connected to the first interface circuit, the storage module, and the second interface circuits.

Preferably, the power control circuit comprises a first MOS transistor Q2, a second MOS transistor Q4, and a power control chip U2. A first port VBUS_IN_DET of the power control chip U2 is connected to the VBUS port of the first Type-C plug J1. A second port CC_E and a third port CC_F of the power control chip U2 are respectively connected to the CC1 port and CC2 port of the first Type-C plug J1. A power input terminal of the power control chip U2 is connected to the voltage bus VBUS. A fourth port CC_A of the power control chip U2 is connected to the first interface circuit. A fifth port C_VBUS_EN1 of the power control chip U2 is connected to a gate of the second MOS transistor Q4. A source of the second MOS transistor Q4 is connected to ground. A drain of the second MOS transistor Q4 is connected to a gate of the first MOS transistor Q2. A source of the first MOS transistor Q2 is connected to the VBUS port of the first Type-C plug J1. A drain of the first MOS transistor Q2 is connected to the first interface circuit and a sixth port VBUS_OUT_DET of the power control chip U2.

Preferably, the storage module comprises a storage main control chip U3 and a memory U4 electrically connected to the storage main control chip U3. Power supply terminals of the storage main control chip U3 and the memory U4 are connected to the voltage bus VBUS. A first port DM2 and a second port DP2 of the storage main control chip U3 are connected to the second interface circuits. Third to tenth ports of the storage main control chip U3 are respectively connected to two sets of TXp ports, TXn ports, RXp ports, and RXn ports of the third Type-C plug J3.

Preferably, the second interface circuits are further electrically connected to the storage module. The second interface circuits comprise a data connection plug and an interface expansion chip U3. Power supply terminals of the data connection plug and the interface expansion chip U3 are connected to the voltage bus VBUS. A data transmission port of the data connection plug is connected to a data input port of the interface expansion chip U3. A first data output port of the interface expansion chip U3 is connected to the first interface circuit. A second data output port of the interface expansion chip U3 is connected to the storage module.

Preferably, the data connection plug is a second Type-C plug J2, and the interface expansion chip U3 is an SL2.1S chip.

According to a second aspect, the present disclosure further provides a multifunctional adapter, comprising a main control board and the adapter control circuit with storage functionality as described in the first aspect disposed on the main control board.

The embodiments of the present disclosure provide the following beneficial effects:

Through the first interface circuit, the adapter control circuit connects to a mobile device. The mobile device can be charged via the power input circuit connected to an external power source, can expand storage capacity via the storage module, and can simultaneously connect to multiple functional devices via the plurality of second interface circuits. As a result, the interface expandability of the mobile device is enhanced, thereby improving the convenience of use.

In the above embodiments, the multifunctional adapter and the corresponding adapter control circuit with storage functionality are based on the same inventive concept and thus achieve the same technical effects, which will not be described in detail again herein.

In addition to the objectives, features, and advantages described above, the embodiments of the present disclosure also have other objectives, features, and advantages. These will be further described in detail below with reference to the accompanying drawings.

### BRIEF DESCRIPTION OF THE DRAWINGS

The accompanying drawings, which constitute a part of the present disclosure, are provided to further illustrate the embodiments of the present invention and are intended to facilitate an understanding of the exemplary embodiments and their explanations. The drawings should not be construed as unduly limiting the scope of the invention. In the drawings:

FIG. 1 is a schematic circuit diagram of the first interface circuit according to an embodiment of the present disclosure.

FIG. 2A is a schematic structural diagram of the power connection plug of the power input circuit according to an embodiment of the present disclosure.

FIG. 2B is a schematic partial circuit diagram of the power control circuit of the power input circuit according to an embodiment of the present disclosure.

FIG. 2C is another schematic partial circuit diagram of the power control circuit of the power input circuit according to an embodiment of the present disclosure.

FIG. 2D is a schematic circuit diagram of the power conversion circuit of the power input circuit according to an embodiment of the present disclosure.

FIG. 3A is a schematic circuit diagram of the storage module according to an embodiment of the present disclosure.

FIG. 3B is a schematic diagram of partial pin connections of the power control chip of the storage module according to an embodiment of the present disclosure.

FIG. 4 is a schematic circuit diagram of the second interface circuit according to an embodiment of the present disclosure.

FIG. 5 is a schematic diagram of the internal structure of a multifunctional adapter according to another embodiment of the present invention.

The reference numerals in the drawings are as follows:
1—first interface circuit;
11—mobile device connection plug;
2—power input circuit;
21—power connection plug;
22—power control circuit;
23—power conversion circuit;
3—storage module;
4—second interface circuit;
41—data connection plug.

### DETAILED DESCRIPTION OF THE EMBODIMENTS

The following detailed description of the embodiments of the present disclosure is provided in conjunction with the accompanying drawings.

Unless otherwise defined, technical terms or scientific terms used herein shall have the meanings commonly understood by those skilled in the art to which the present disclosure pertains.

Terms such as “upper,” “lower,” “left,” “right,” “center,” “vertical,” “horizontal,” “inner,” and “outer,” as used in the present disclosure, are intended to describe relative positions or relationships and are not intended to imply any absolute orientation or configuration of a device or element.

When the absolute position of the described object changes, the relative positional relationships may also change accordingly; therefore, these terms should not be construed as limiting the present disclosure.

The terms “first,” “second,” “third,” and similar expressions as used herein are intended solely for the purpose of distinguishing between different components or elements, and should not be construed to imply any relative importance.

The terms such as “a,” “an,” or “the” are not intended to limit the quantity but should be interpreted to mean “at least one” unless otherwise specified.

Terms such as “comprise” or “include” are intended to indicate that the elements or objects listed after the term are encompassed, but do not exclude the presence of other elements or objects not expressly listed.

It should also be understood that, unless otherwise explicitly specified or limited, the terms such as “mounted,” “connected,” or “coupled” as used herein are intended to be interpreted broadly.

For example, a connection may be a fixed connection, a detachable connection, or an integrally formed connection; it may be a mechanical connection or an electrical connection; it may be a direct connection or an indirect connection through an intermediary; or it may involve internal communication between components.

Those skilled in the art can interpret the specific meanings of these terms in the context of the present disclosure according to the specific circumstances.

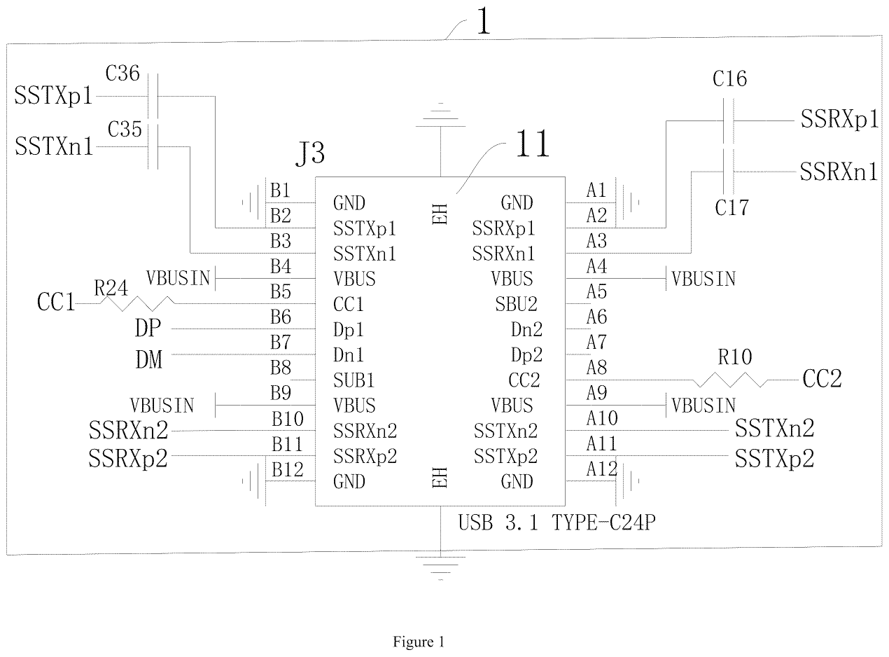

As shown in FIGS. 1 to 5, the adapter control circuit with storage functionality according to the present embodiment comprises a first interface circuit 1 configured to connect to a mobile device, and a power input circuit 2, a storage module 3, and a plurality of second interface circuits 4, all electrically connected to the first interface circuit 1.

The power input circuit 2 is configured to connect to an external power source, and the second interface circuits 4 are configured to connect to external functional devices.

The first interface circuit 1 comprises a mobile device connection plug 11.

The mobile device may be a mobile phone, tablet, or other device configured to mate with the mobile device connection plug 11.

In the present embodiment, a mobile phone is used as an example for illustration.

The external power source may be a charger, a power bank, or any device capable of providing power.

In this embodiment, a charger connected to a mains power supply is used as an example.

The second interface circuits 4 may be configured as one or more interfaces according to actual requirements.

In the present embodiment, one second interface circuit 4 is used as an example.

The external functional device may be a headphone, a microphone receiver, or another type of functional device.

In this embodiment, a microphone receiver is used as an example to enable the mobile phone to receive microphone data.

Specifically, when the mobile device connection plug 11 is inserted into the mobile phone, the power input circuit 2 may connect to the charger, thereby supplying power to the mobile phone, as well as to the storage module 3 and the second interface circuit 4.

It should be noted that when the power input circuit 2 is not connected to an external power source, the mobile phone can also serve as a power source to supply power to the storage module 3 and the second interface circuit 4.

This allows the mobile phone to store data into the storage module 3, thereby achieving the function of external storage expansion.

Additionally, the mobile phone may connect to the microphone receiver via the second interface circuit 4 to receive microphone data.

The charging function, storage expansion function, and microphone data reception function can be performed simultaneously, thereby enabling interface expansion for the mobile device and improving convenience in practical use.

In some embodiments, the first interface circuit 1 comprises a mobile device connection plug 11, which may be a Type-C plug, a Micro USB plug, or a Lightning plug.

It should be understood that the mobile device connection plug 11 is configured to connect the adapter to the mobile device.

Depending on the type of interface used by different mobile devices, the first interface circuit 1 in the present embodiment may adopt different corresponding mobile device connection plugs 11.

For example, an iPhone may use a Lightning plug, while Android phones may use a Type-C plug or a Micro USB plug.

In some embodiments, as shown in FIG. 1, the mobile device connection plug 11 is a third Type-C plug J3.

The Dp and Dn pins of the Type-C plug are electrically connected to the second interface circuit 4.

The VBUS pin of the Type-C plug is connected to the power input circuit 2.

The CC1 pin of the third Type-C plug J3 is connected to both the power input circuit 2 and the storage module 3.

The CC2 pin of the third Type-C plug J3 is connected to the storage module 3.

Two sets of TXp, TXn, RXp, and RXn pins of the third Type-C plug J3 are respectively connected to eight corresponding pins of the storage module 3.

The GND pin of the third Type-C plug J3 is connected to ground.

Specifically, the third Type-C plug J3 is a 24-pin USB 3.1 Type-C plug.

The VBUS pin of the third Type-C plug J3 is connected to the power input circuit 2 and is configured to provide charging power to the mobile phone.

When the power input circuit 2 is not connected to an external power source, the VBUS pin of the third Type-C plug J3 can also act as a voltage bus VBUS to supply power to the second interface circuit 4 and the storage module 3.

The CC1 and CC2 pins of the third Type-C plug J3 are capable of detecting the orientation of insertion (normal or reverse), determining the connection status of the device, identifying the data transmission direction, managing power delivery, and supporting USB Power Delivery (USB PD) functionality.

In the present embodiment, the CC1 pin of the third Type-C plug J3 is connected to both the power input circuit 2 and the storage module 3, and the CC2 pin is connected to the storage module 3, such that both the power input circuit 2 and the storage module 3 can store control programs for managing the third Type-C plug J3.

The Dp and Dn pins of the Type-C plug are electrically connected to the second interface circuit 4 for receiving data from the second interface circuit 4.

The two sets of TXp, TXn, RXp, and RXn pins of the third Type-C plug J3 are respectively connected to eight corresponding pins of the storage module 3, enabling efficient data transmission between the mobile phone and the storage module 3.

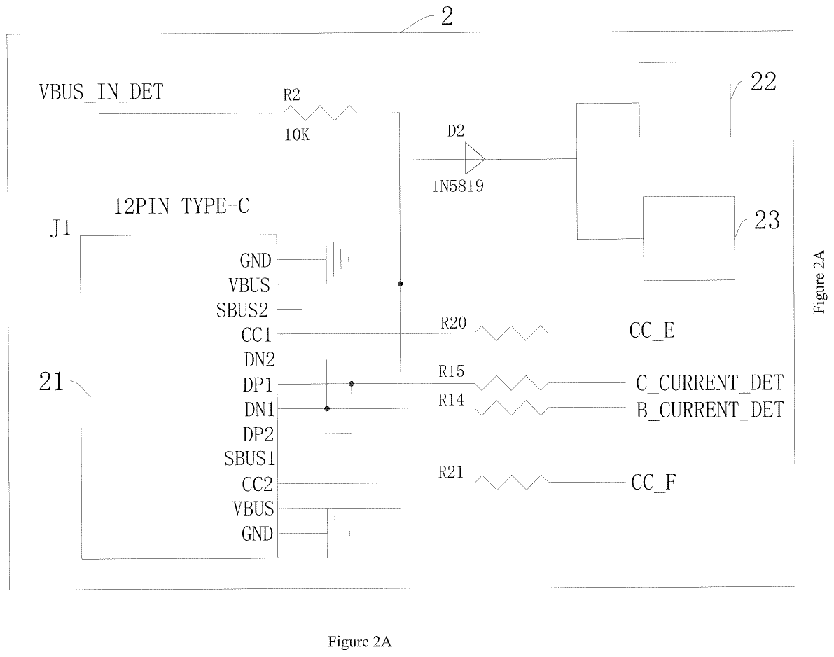

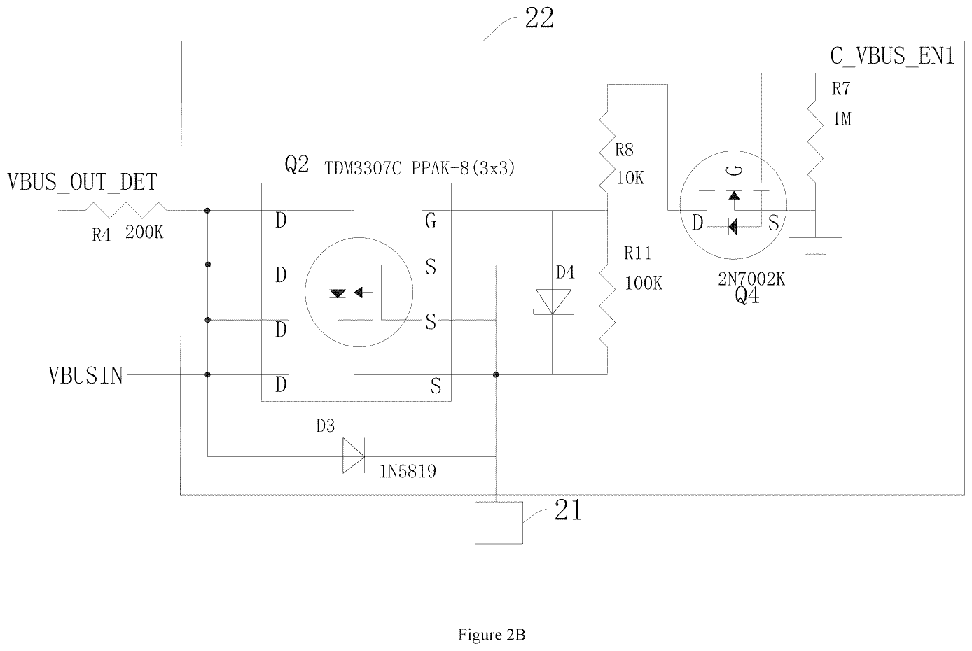

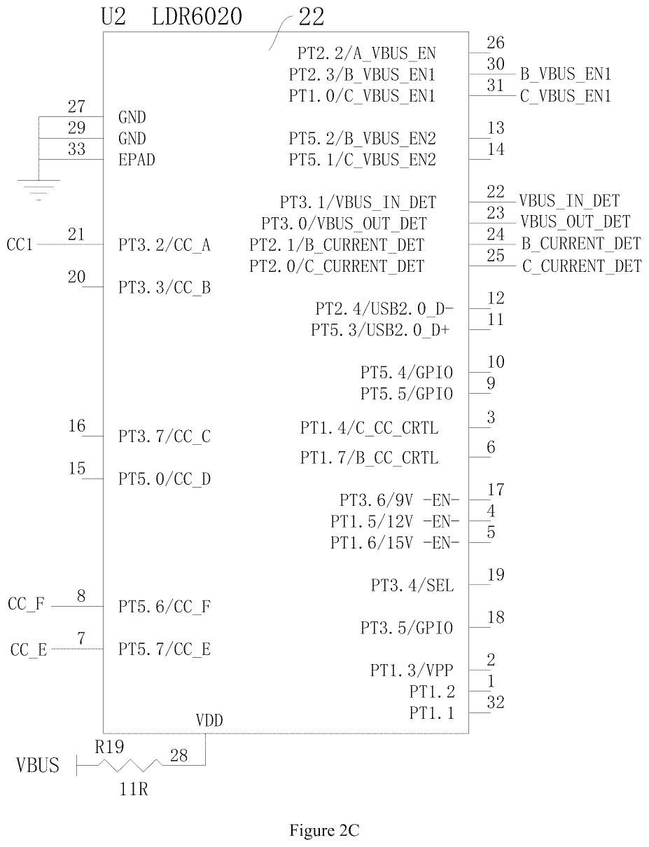

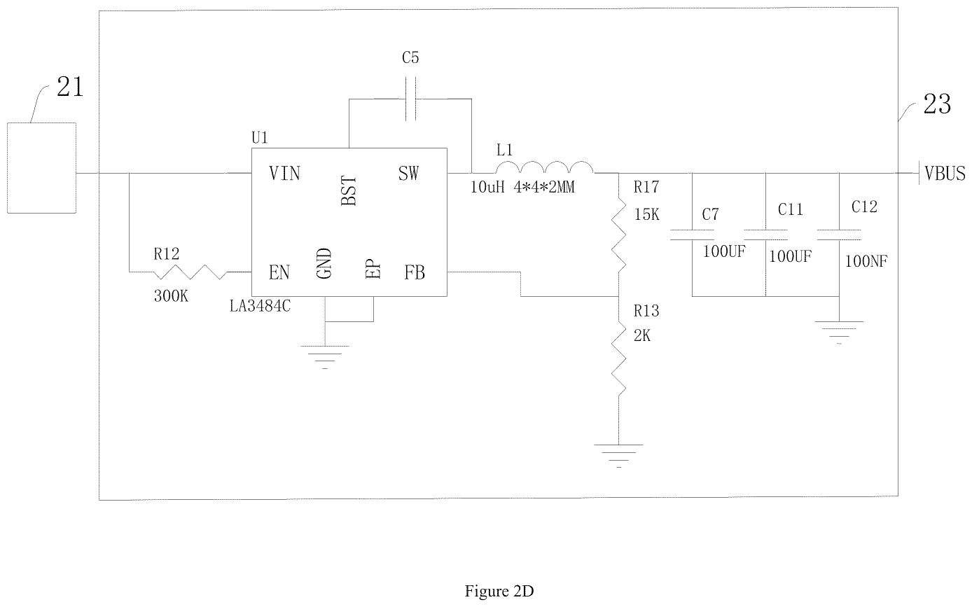

In this embodiment, as illustrated in FIGS. 2A to 2D, the power input circuit 2 comprises a power connection plug 21, a power control circuit 22, and a power conversion circuit 23.

The power connection plug 21 is configured to connect to an external power source.

The power control circuit 22 and the power conversion circuit 23 are electrically connected to the power connection plug 21.

The power control circuit 22 is electrically connected to the first interface circuit 1 and the second interface circuit 4.

Specifically, the power connection plug 21 is configured to connect to a charger or a power bank to allow the introduction of an external power supply.

In the present embodiment, a charger connected to a mains power supply is used as an example for illustration.

The power control circuit 22 is configured to manage the charging power and to control the on/off switching of the charging path.

The power conversion circuit 23 is configured to adjust the voltage level.

When the power connection plug 21 is connected to an external power source, the output terminal of the power conversion circuit 23 provides the converted voltage to the storage module 3 and the second interface circuit 4.

In some embodiments, as illustrated in FIGS. 2A and 2D, the power connection plug 21 is a first Type-C plug J1.

The power conversion circuit 23 comprises a DC-DC power chip U1 and an inductor L1.

An input terminal of the DC-DC power chip U1 is electrically connected to the VBUS port of the first Type-C plug J1.

An output terminal of the DC-DC power chip U1 is electrically connected to a first end of the inductor L1.

A second end of the inductor L1 is electrically connected to the voltage bus (VBUS).

The output port of the VBUS is electrically connected to the first interface circuit 1, the storage module 3, and the second interface circuit 4.

In this embodiment, the DC-DC power chip U1 is specifically a model LA3484C, and the first Type-C plug J1 is a 12-pin Type-C interface.

The VBUS port of the first Type-C plug J1 is electrically connected to the DC-DC power chip U1.

The DC-DC power chip U1 is configured to process the input voltage and output a stabilized voltage.

The output voltage passes through the inductor L1, the resistors R3 and R17, and the capacitors C7, C11, and C12 for filtering, and is then delivered to the voltage bus (VBUS).

The voltage bus VBUS is electrically connected to the power control circuit 22, the storage module 3, and the second interface circuit 4 to supply power thereto.

In this embodiment, the VBUS from the first Type-C plug J1 passes through the power control circuit 22 and is then directly connected to the third Type-C plug J3 of the first interface circuit 1.

It should be noted that, in other embodiments, the third Type-C plug J3 of the first interface circuit 1 may also be directly powered through the voltage bus VBUS.

In some embodiments, as illustrated in FIGS. 2B and 2C, the power control circuit 22 comprises a first MOS transistor Q2, a second MOS transistor Q4, and a power control chip U2.

A first port VBUS_IN_DET of the power control chip U2 is electrically connected to the VBUS port of the first Type-C plug J1.

A second port CC_E and a third port CC_F of the power control chip U2 are respectively electrically connected to the CC1 port and the CC2 port of the first Type-C plug J1.

A power input terminal of the power control chip U2 is electrically connected to the voltage bus (VBUS).

A fourth port CC_A of the power control chip U2 is electrically connected to the first interface circuit 1.

A fifth port C_VBUS_EN1 of the power control chip U2 is electrically connected to the gate of the second MOS transistor Q4.

The source of the second MOS transistor Q4 is connected to ground, and the drain of the second MOS transistor Q4 is electrically connected to the gate of the first MOS transistor Q2.

The source of the first MOS transistor Q2 is electrically connected to the VBUS port of the first Type-C plug J1, and the drain of the first MOS transistor Q2 is electrically connected to the first interface circuit 1 and to a sixth port VBUS_OUT_DET of the power control chip U2.

In this embodiment, the first MOS transistor Q2 is a P-channel MOSFET, and the second MOS transistor Q4 is an N-channel MOSFET.

The power control chip U2 is specifically an LDR6020.

The LDR6020 is configured to output multiple configuration channel (CC) signals to connect to the Type-C interface and control the operation of the Type-C interface.

In addition, the LDR6020 is further configured to output control signals to drive the switching states of the MOS transistors.

Specifically, a first port VBUS_IN_DET of the power control chip U2 is electrically connected to the VBUS port of the first Type-C plug J1 via a resistor R2.

When the first Type-C plug J1 is connected to an external power source, the power control chip U2 is powered on.

The VBUS port of the first Type-C plug J1 is directly connected to the first port VBUS_IN_DET of the power control chip U2, thereby triggering the power control chip U2 to enter a working mode.

A second port CC_E and a third port CC_F of the power control chip U2 are electrically connected to the CC1 port and the CC2 port of the first Type-C plug J1, respectively, via resistors R20 and R21.

A fourth port CC_A of the power control chip U2 is configured to output a CC1 signal, which is electrically connected to the CC1 port of the third Type-C plug J3 of the first interface circuit 1 via a resistor R24.

The power control chip U2 is configured to recognize the insertion orientation (normal or reverse) between the first Type-C plug J1 and the third Type-C plug J3, negotiate voltage and current parameters, and dynamically adjust the power delivery accordingly.

A fifth port C_VBUS_EN1 of the power control chip U2 is electrically connected to the gate of the second MOS transistor Q4 to control its switching operation.

When the fifth port C_VBUS_EN1 outputs a control signal causing the second MOS transistor Q4 to conduct, the gate voltage of the second MOS transistor Q4 is pulled to ground through resistor R8, resulting in a gate voltage lower than the source voltage and thereby turning on the second MOS transistor Q4.

Consequently, the voltage output from the VBUS port of the first Type-C plug J1 passes through the second MOS transistor Q4 and is delivered to the VBUS port of the third Type-C plug J3 to charge the mobile device.

Simultaneously, the voltage is also delivered to a sixth port VBUS_OUT_DET of the power control chip U2, enabling the power control chip U2 to detect the power supply state between the first Type-C plug J1 and the third Type-C plug J3.

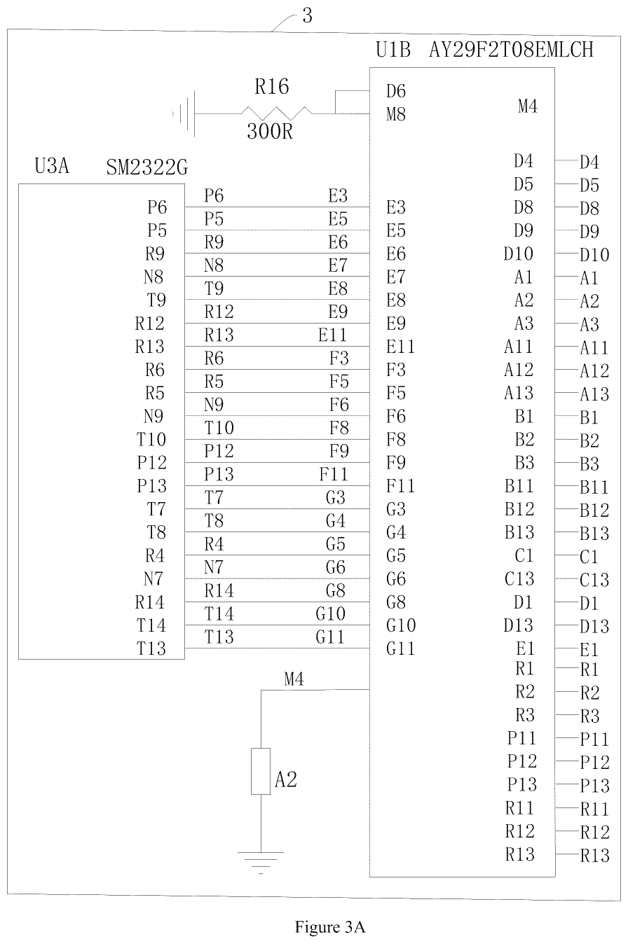

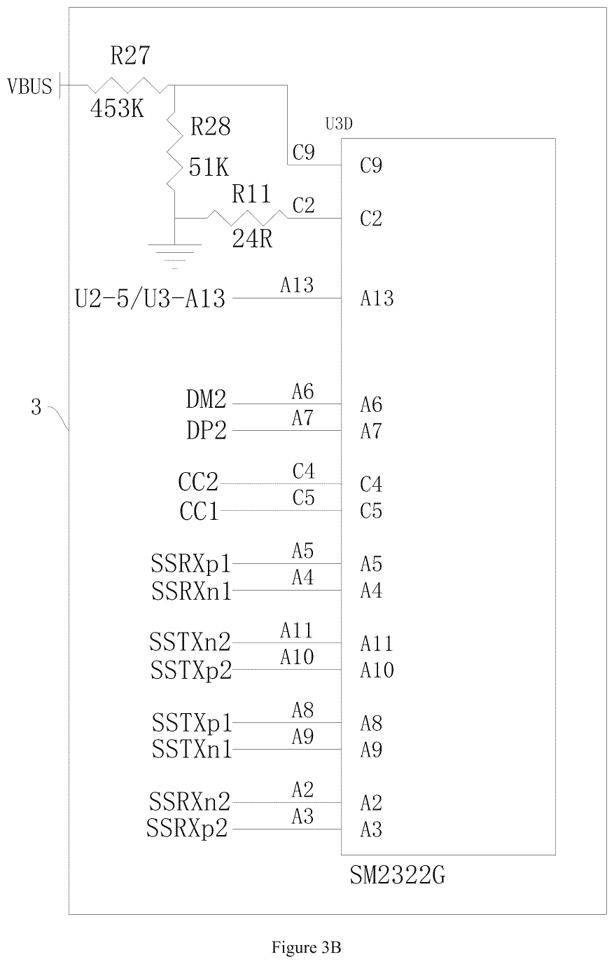

In some embodiments, as illustrated in FIGS. 3A and 3B, the storage module 3 comprises a storage master control chip U3 and a memory U4 electrically connected to the storage master control chip U3.

A power supply port of the storage master control chip U3 is electrically connected to the voltage bus (VBUS).

A first port DM2 and a second port DP2 of the storage master control chip U3 are electrically connected to the second interface circuit 4.

Third through tenth ports of the storage master control chip U3 are respectively electrically connected to two sets of TXp, TXn, RXp, and RXn ports of the third Type-C plug J3.

In this embodiment, the storage master control chip U3 is specifically an SM2322G chip, and the memory U4 is specifically an AY29F2T08EMLCH chip.

A power supply terminal of the SM2322G chip is electrically connected to the voltage bus (VBUS).

The SM2322G chip is configured to be powered either through the first Type-C plug J1 of the power input circuit 2 or directly through the mobile device.

Specifically, third through tenth ports of the storage master control chip U3 are respectively electrically connected to two sets of TXp, TXn, RXp, and RXn ports of the third Type-C plug J3.

The TXp, TXn, RXp, and RXn ports of the third Type-C plug J3 are configured to transmit data simultaneously to achieve USB 3.1 data transmission.

The two sets of ports of the third Type-C plug J3 exchange data concurrently with the SM2322G chip to enable high-efficiency data transfer.

The SM2322G chip and the AY29F2T08EMLCH memory chip are interconnected through forty pins to facilitate fast data storage and retrieval.

A first port DM2 and a second port DP2 of the storage master control chip U3 are electrically connected to the second interface circuit 4, allowing data from the microphone receiver connected to the second interface circuit 4 to be directly stored in the memory U4.

The memory U4 may also store control programs.

Furthermore, an eleventh port CC1 and a twelfth port CC2 of the SM2322G chip are electrically connected to the CC1 and CC2 ports of the third Type-C plug J3 of the first interface circuit 1, thereby enabling dynamic adjustment of power delivery and control of the data transmission mode and rate according to the transmission protocol.

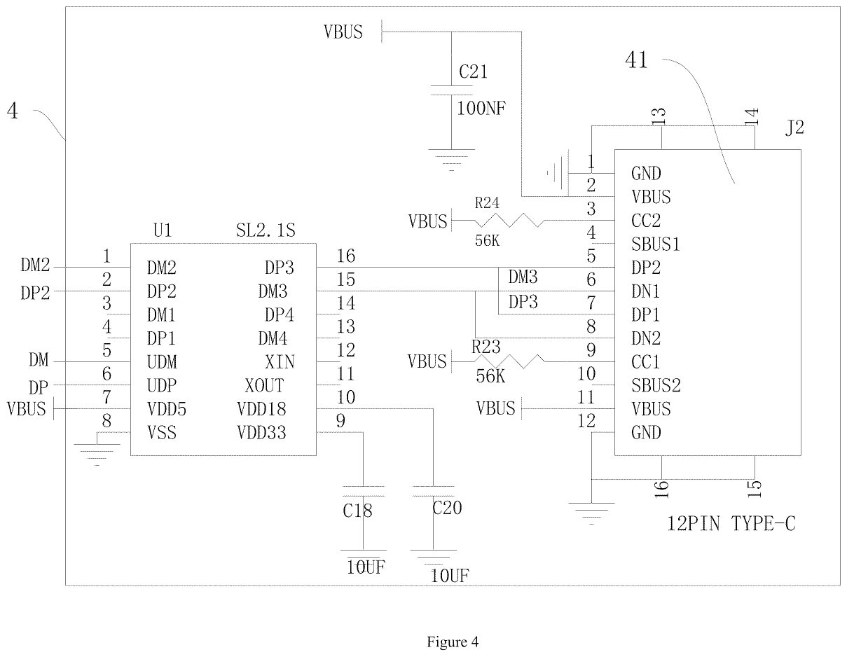

In some embodiments, as illustrated in FIG. 4, the second interface circuit 4 is also electrically connected to the storage module 3.

The second interface circuit 4 comprises a data connection plug 41 for connecting to external functional devices and an interface expansion chip U3.

Power supply terminals of both the data connection plug 41 and the interface expansion chip U3 are electrically connected to the voltage bus (VBUS).

A data transmission port of the data connection plug 41 is electrically connected to a data input port of the interface expansion chip U3.

A first data output port of the interface expansion chip U3 is electrically connected to the first interface circuit 1.

A second data output port of the interface expansion chip U3 is electrically connected to the storage module 3.

In this embodiment, the data connection plug 41 of the second interface circuit 4 is specifically a 12-pin second Type-C plug J2, which is configured to connect to a microphone receiver.

The interface expansion chip U3 is specifically an SL2.1S chip.

The SL2.1S chip is configured to expand a single DM/DP data channel into multiple DM/DP data outputs.

Specifically, when the second Type-C plug J2 is connected to a microphone receiver, the VBUS interface of the second Type-C plug J2 and the power supply terminal VDD of the SL2.1S chip are both electrically connected to the voltage bus (VBUS).

A DN port and a DP port of the second Type-C plug J2 are respectively electrically connected to a first DM port and a first DP port of the SL2.1S chip.

A second DM port and a second DP port of the SL2.1S chip are respectively electrically connected to a first port DM2 and a second port DP2 of the storage master control chip U3, thereby enabling data received from the microphone receiver to be directly stored in the memory U4.

A third DM port and a third DP port of the SL2.1S chip are respectively electrically connected to the DN port and DP port of the third Type-C plug J3 of the first interface circuit 1, thereby enabling data received from the microphone receiver to be transmitted to the mobile device.

The adapter control circuit with storage functionality provided in the foregoing embodiments of the present disclosure offers at least the following advantages:
(1) The mobile device connects to an external power source, the memory U4, and a microphone receiver through various ports of the third Type-C plug J3.

Since the external power source, the memory U4, and the microphone receiver occupy different ports of the third Type-C plug J3, the mobile device can simultaneously perform charging, data reading from the memory U4, and data reception from the microphone receiver.

Thus, multiple functions can be achieved via a single interface, significantly enhancing ease of use.
(2) Even when no external power source is connected, the mobile device itself can supply power, enabling external storage functionality and data acquisition from the microphone receiver.

The storage module can also store transmission protocols and charging protocols to control the operation of the third Type-C plug J3.

Data received from the microphone receiver can be directly stored into the storage module, thereby saving the internal memory space of the mobile device.

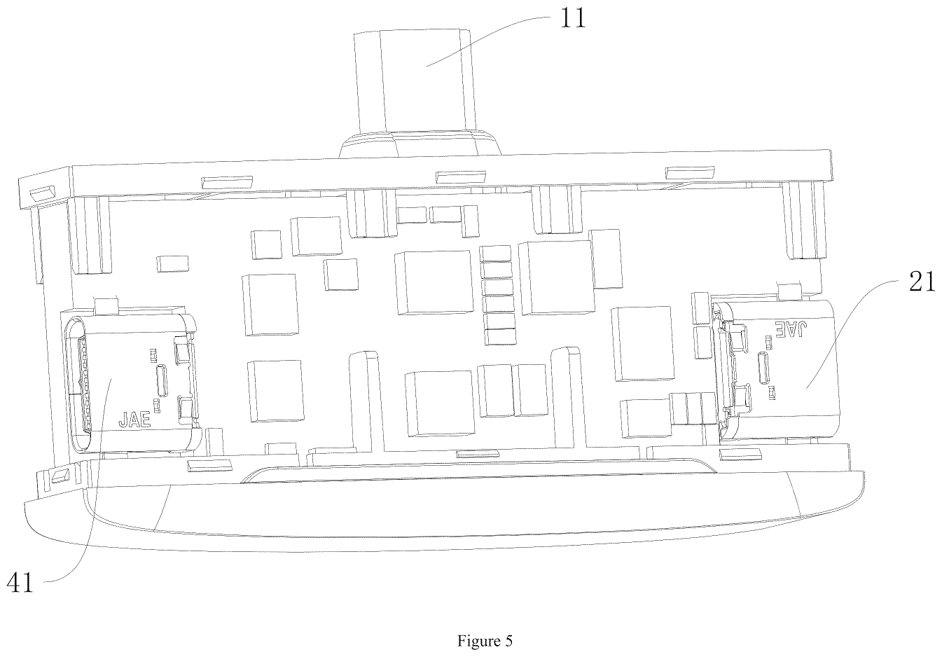

As shown in FIG. 5, the present disclosure further provides a multifunctional adapter, comprising a main control board and the adapter control circuit with storage functionality as described in the foregoing embodiments, mounted on the main control board.

In this embodiment, three Type-C plugs are provided on the main control board, respectively configured for connection to a mobile device, a power source, and external functional devices.

This configuration enables the multifunctional adapter to expand the interfaces of the mobile device and provide external storage functionality.

The foregoing description merely illustrates preferred embodiments of the present disclosure and is not intended to limit the scope of the disclosure.

It should be understood by those skilled in the art that various modifications, substitutions, and improvements may be made without departing from the spirit and principles of the present disclosure.

Any modifications, equivalent replacements, or improvements that fall within the spirit and principles of the present disclosure are intended to be encompassed within the scope of protection of the present disclosure.

What is claimed is:

1. A control circuit for an adapter with storage functionality, characterized in that it comprises:
a first interface circuit (1) configured to be connected to a mobile device;
a power input circuit (2), a storage module (3), and a plurality of second interface circuits (4), all electrically connected to the first interface circuit (1);
wherein the power input circuit (2) is configured to be connected to an external power source; and the second interface circuits (4) are configured to be connected to external functional devices.

2. The control circuit for an adapter with storage functionality according to claim 1, wherein the first interface circuit (1) comprises a mobile device connection plug (11), and the connection plug (11) is a Type-C plug, a Micro USB plug, or a Lightning plug.

3. The adapter control circuit with storage functionality according to claim 2, wherein the mobile device connection plug (11) is a third Type-C plug (J3),
wherein Dp and Dn ports of the third Type-C plug (J3) are electrically connected to the second interface circuits (4),
a VBUS port of the third Type-C plug (J3) is electrically connected to the power input circuit (2),
a CC1 port of the third Type-C plug (J3) is electrically connected to both the power input circuit (2) and the storage module (3),
a CC2 port of the third Type-C plug (J3) is electrically connected to the storage module (3),
two sets of TXp ports, TXn ports, RXp ports, and RXn ports of the third Type-C plug (J3) are respectively electrically connected to eight corresponding ports of the storage module (3), and
a GND port of the third Type-C plug (J3) is connected to ground.

4. The adapter control circuit with storage functionality according to claim 1,
wherein the power input circuit (2) comprises a power connection plug (21), a power control circuit (22), and a power conversion circuit (23),
wherein the power connection plug (21) is configured to connect to an external power source,
the power control circuit (22) and the power conversion circuit (23) are connected to the power connection plug (21),
the power control circuit (22) is electrically connected to the first interface circuit (1) and the second interface circuits
and a power output terminal of the power conversion circuit (23) is electrically connected to the storage module (3) and the second interface circuits (4).

5. The adapter control circuit with storage functionality according to claim 4,
wherein the power connection plug (21) is a first Type-C plug J1,
the power conversion circuit (23) comprises a DC-DC power chip U1 and an inductor L1,
an input terminal of the DC-DC power chip U1 is connected to a VBUS port of the first Type-C plug J1,
an output terminal of the DC-DC power chip U1 is connected to a first end of the inductor L1,
a second end of the inductor L1 is connected to a voltage bus VBUS,
and a VBUS output port is connected to the storage module (3) and the second interface circuits (4).

6. The adapter control circuit with storage functionality according to claim 5,
wherein the power control circuit (22) comprises a first MOS transistor Q2, a second MOS transistor Q4, and a power control chip U2,
wherein a first port VBUS_IN_DET of the power control chip U2 is connected to a VBUS port of the first Type-C plug J1,
a second port CC_E and a third port CC_F of the power control chip U2 are respectively connected to a CC1 port and a CC2 port of the first Type-C plug J1,
a power input terminal of the power control chip U2 is connected to the voltage bus VBUS,
a fourth port CC_A of the power control chip U2 is connected to the first interface circuit (1),
a fifth port C_VBUS_EN1 of the power control chip U2 is connected to a gate of the second MOS transistor Q4,
a source of the second MOS transistor Q4 is connected to ground,
a drain of the second MOS transistor Q4 is connected to a gate of the first MOS transistor Q2,
a source of the first MOS transistor Q2 is connected to the VBUS port of the first Type-C plug J1,
and a drain of the first MOS transistor Q2 is connected to the first interface circuit (1) and a sixth port VBUS_OUT_DET of the power control chip U2.

7. The adapter control circuit with storage functionality according to claim 3,
wherein the storage module (3) comprises a storage main control chip U3 and a memory U4 electrically connected to the storage main control chip U3,
wherein power supply terminals of the storage main control chip U3 and the memory U4 are connected to the voltage bus VBUS,
a first port DM2 and a second port DP2 of the storage main control chip U3 are connected to the second interface circuits (4),
and third to tenth ports of the storage main control chip U3 are respectively connected to two sets of TXp ports, TXn ports, RXp ports, and RXn ports of the third Type-C plug J3.

8. The adapter control circuit with storage functionality according to claim 1,
wherein the second interface circuits (4) are further electrically connected to the storage module (3),
wherein the second interface circuits (4) comprise a data connection plug (41) configured to connect to functional devices and an interface expansion chip U3,
wherein power supply terminals of the data connection plug (41) and the interface expansion chip U3 are connected to the voltage bus VBUS,
a data transmission port of the data connection plug (41) is connected to a data input port of the interface expansion chip U3,
a first data output port of the interface expansion chip U3 is connected to the first interface circuit (1),
and a second data output port of the interface expansion chip U3 is connected to the storage module (3).

9. The adapter control circuit with storage functionality according to claim 8,
wherein the data connection plug (41) is a second Type-C plug J2,
and the interface expansion chip U3 is an SL2.1S chip.

10. A multifunctional adapter, comprising a main control board and the adapter control circuit with storage functionality according to claim 1, disposed on the main control board.
